(19) United States
(12) Patent Application Publication
(10) Pub. No.: US 2006/0275563 A1
(43) Pub. Date: Dec. 7, 2006

(54) Biodegradable and compostable material

(76) Inventor: Kevin Duffy, Bend, OR (US)

Correspondence Address: PETER A. HAAS, ESQUIRE, 1929 SW 13TH AVENUE, PORTLAND, OR, 97201, US

(21) Appl. No.: 11/446,780

(22) Filed: Jun. 5, 2006

Related U.S. Application Data
(60) Provisional application No. 60/687,693, filed on Jun. 6, 2005.

(51) Int. Cl. B32B 27/10

(52) U.S. Cl. 428/34.2

(57) ABSTRACT

The present invention comprises an impermeable coating on an organic substrate resulting in a material that is inert, environmentally safe, impermeable and fully compostable and biodegradable. The present invention, therefore, is ideally suited to meet the ever-growing demand for compostable containers, as used in the food, beverage, agricultural, consumer products, medical, and waste industries, for example, including vacuum packaging and anti-static packaging. A possible substrate, such as a cellulose or polyactide (PLA) film and a possible coating, such as a ceramic coating of SiO₂ (silicon di-oxide), are derived from organic substances and, thus, both completely degrade under natural conditions. Moreover, this biodegradation can occur under compost conditions as defined in numerous international standards, including at least ASTM D 6400.

### PRIORITY CLAIM

This application claims priority to co-pending provisional patent application No. 60/687,693 titled “Biodegradable Material for Retaining Consumables” filed on 07 Jun. 2005 by the same inventor.

### BACKGROUND

The present invention relates to a biodegradable material. The material comprises a substrate and a coating that, when combined, results in an impermeable barrier, making the material suitable for consumables containers, gas, solid or liquid storage vessels, product containers, storage container, and the like. The material is particularly suited for use as food-stuff packaging, for example, for snacks, energy bars, and cookies. Further, the material is well-suited for prepared meals, valve closer material for coffee bags, valves for juice containers, and the like. Further, the biodegradable and compostable material revolutionizes waste disposal management and systems.

Waste, especially waste as a result of discarded containers used in the food, beverage, medical, agricultural, recreational, construction, electronics, and consumer industries, remains a growing problem for our modern society. The United States alone—despite a recent effort to reduce, reuse, and recycle—contributes nearly twenty-five percent of the planet's waste.

Europe also faces the same waste disposal problem. And, in fact, several European cities have attempted to ban multi-ply structures due to the inability of such material to degrade.

Plastic products, which not only consume foreign-based petrochemicals and create greenhouse gas emissions during production, also contribute to the waste problem in the United States. For example, in 1995, U.S. landfills buried an estimated 20 million tons of plastic products. And plastics, although a very popular material with numerous applications in diverse industries, suffer an important and significant disadvantage—they resist biodegradation.

The introduction of biodegradable plastics, a material that degrades as a result of naturally occurring microorganisms, such as bacteria, fungi, and algae, attempted to solve the disposal problems of plastics. Typically, biodegradable plastics combine starch-based formulations with petroleum-based resins. This unique formulation of organic and inorganic chemical materials was touted as the solution to the waste problem and, although biodegradable plastics offer many of the desired aspects of plastics and degrade when exposed to sunlight, the majority of biodegradable plastics end up in landfills; thus, the disposal problem is not adequately addressed.

One example of biodegradable plastics, U.S. Pat. No. 5,580,624 to Andersen, describes food and beverage containers made from inorganic aggregates and polysaccharide, protein, or synthetic organic binders. The Andersen reference describes compositions, methods, and an apparatus for manufacturing sheets having a highly inorganically filled matrix. Suitable inorganically filled mixtures are prepared by mixing together an organic polymer binder, water, one or more aggregate materials, fibers, and optional admixtures in the correct proportions to form a sheet. The sheets are formed by first extruding the mixtures and the passing the extruded materials between a set of rollers. The rolled sheets are dried in an accelerated manner to form a substantially hardened sheet, such as by heated rollers and/or a drying chamber. This attempt, however, continues to use inorganic and petrochemical materials. And, thus, this attempt does not fully address the waste disposal problem.

Biodegradation, as a preferred disposal method, predates written history. It is not surprising; therefore, that many natural products were used as containers before plastics dominated the packaging industry. For example, paper and related natural fiber products, including cellulose, were routinely used prior to plastic's dominance. However, prior-art natural fiber products have significant drawbacks. For example, the natural fiber materials permeate oxygen, other gases, and liquids. This led to an unacceptable level of food spoliation, container leakage, and other related contamination issues.

More recently, greater awareness of the hazards of petrochemicals combined with volatile foreign markets (home of a vast majority of the oil reserves) has pushed the container market to seek new solutions to the waste problem of plastics. In addition, biodegradation in landfills cannot keep pace with society's ever-growing amount of waste. Space is limited and many landfills are at capacity: Another solution is desperately needed.

Communities are now looking to composing as a solution to waste disposal. Composting, however, requires that the waste be both biodegradable and compostable. Substitution of traditional packaging with a material that is both biodegradable and compostable will dramatically change the current waste-management and disposal systems of most communities. Currently, the waste-management and disposal systems are centralized, requiring a fleet of vehicles to collect waste and haul it to a central location where it is processed. By eliminating traditional packaging material and substituting it with materials that are both biodegradable and compostable, point-of-use waste-management and disposal systems are possible. In stead of weekly curb-side waste pick-ups of the current system, a new system of disposal includes the waste-generator to self-dispose of the material in, for example, a residential back-yard compost bin.

At the federal level in the United States, there is a movement to decrease dependence on foreign oil and petroleum-based products and replace this demand with a demand for U.S. agriculture—using renewable crops as a fuel source and as a replacement of petrochemical-based products. This would create a demand for U.S. crops, many of which receive substantial subsidies from the government. One benefit of many bio-based products stemming from renewable, U.S.-grown crops is the products can be compostable and biodegradable.

Composting requires short-term degradation of material under aerobic conditions and refers to the process of biological decomposition into carbon dioxide, water, inorganic compounds, and biomass. ASTM D 6400, an industry standard for composting, details the test conditions and specifications for compostable materials. These tests, moreover, indicate that biodegradable plastics are typically ill suited to composting requirements.

One attempt to produce a biodegradable and compostable Hayes describes material suitable for containers in the published application no. 2004/0254332 on 11 Jun. 2003. The Hayes reference describes an aliphatic-aromatic polyetherester composition and related articles, films, coating, and laminates and processes. Some of the compositions and articles are biocompatible. The films can further be used to form shaped articles such as sheets, food packaging such as sandwich wraps, thermoformed containers, and coatings for, for example, films and other substrates. The aliphatic-aromatic polyetheresters are based on co polyesters produced from a mixture of aromatic dicarboxylic acids, aliphatic dicarboxylic acids, poly (alkenes ether) glycols, and glycols. At present, it is unclear whether this material will meet the requirements of consumers, industry, and waste disposal facilities.

Cellulose, a material that does readily meet the compostable standards, naturally permeates gasses and liquids and, therefore, it is not well-suited for a liquids storage vessel or food-stuffs (consumables) container. To counter this characteristic, prior-art attempts pair cellulose with other materials to improve permeability and strength properties. For example, U.S. Pat. No. 5,178,469 presents a cellulose film, which is biodegradable and compostable, combined with a Kraft-type paper to form a bag suitable for containing solid materials. Although this combination increases the strength, it still permeates liquids and gasses and will eventually leak, or is penetrated, resulting in contamination of the foodstuff contained inside a vessel fabricated from it.

Another attempt to provide a compostable bag suitable for wet waste is described in the published application No. 2003/0079824 filed on 06 Dec. 2002 by Colgan. The Colgan reference describes an energy efficient method and apparatus for manufacturing a biodegradable, compostable, liquid-impermeable lined paper bag for containing wet (i.e. food) wastes by which all adhesives used in the process are cold glues applied without using heat and are applied through an extrusion and/or metering application means. Cellulose film is advantageously used for the paper liner and a dot matrix configuration of adhesive is applied between the cellulose and paper layers to laminate them together. The matrix-defined size of spacing between the points of application of adhesive on the cellulose film is such that both loss of the permeability of the cellulose film to water vapor and oxygen and creation of stress points on the cellulose film are minimized. A second cold glue is applied to the bottom section by a matrix of extrusion adhesives guns and programmable controller for activating the guns whereby the guns are activated according to a program of the controller for applying the second adhesive to pre-determined, programmable areas of the bag bottom section.

Yet, despite advances in polymer technology and attempts to improve cellulose, modern demands that combine compostable requirements with high-performing containers have not been met. Therefore a need exists for a material that can meet modern composting standards, yet offer the impermeable characteristics necessary for liquids containers. In addition there is a need for a compostable material that can be formed into various sized, shaped, and configured consumable containers including flexible, rigid, or films for thermal forming or laminating to form consumables packages.

In addition, there is a growing consumer movement to self-dispose compostable waste in residential composters and over 5 million home-composting units have been sold in North America. A home-garbage or composting system eliminates logistical issues faced by municipalities because compostable waste is handled at the source. Thus, savings are appreciated by reduced usage of commercial collection vehicles and costs associated with municipal collection and sorting centers.

However, even if home composting does not completely eliminate collection, municipal composting can be streamlined. In addition, a by-product of composting is compost soil, which is highly sough-after by gardeners, golf courses, and others. This by-product can be sold to reduce the cost of composting.

In addition to land-based composting, there is a need for waste containers that degrade in a marine environment so that if accidentally the items get into the water and sea they will degrade on there own. Intentional littering on the high seas is a serious problem because many of the waste containers do not suitably degrade in a marine environment. Although it is legal to dispose of garbage beyond a certain distance from shore in international waters, it is often illegal to dispose of waste in harbors or within territorial waters. Despite this restriction, waste disposal occurs due to port disposal fees and limited space on vessels. This creates serious health issues for those aboard the vessels, marine life, and coastal dwellers. However, if appropriate waste disposal is implemented on the high-seas, using bio-degradable containers, than unwanted waste could be utilized as feed for marine life.

### SUMMARY OF THE INVENTION

My invention combines, in a unique, never-been-done-before manner, biodegradable, compostable films (substrates) and a coating of ceramic material. Possible substrate films include cellulose or PLA (polyactide)

Electrostatic charge depositing of the ceramic coating material would advantageously work with the PLA since there is little stretch and both film and coating are clear. Alternatively, a liquid spray of the ceramic coating could be applied to the cellulose film. Or, a bath process incorporating an electrical charge to develop high-strength characteristics.

One advantage of using a thin layer of a ceramic coating on the cellulose substrate results in an inert and impermeable barrier to gasses and liquids. The ceramic coating-layer, typically, is the most expensive item in the structure; therefore, the thinner the coating the more cost effective the structure.

One possible ceramic coating is silicon did-oxide (SiO₂). Silica and silicic acid occur ubiquitously in the environment and some have been used for many years medically. Food contains various amounts of SiO₂; for example, potatoes, milk, drinking water, mineral water, and beer. Accordingly, this invention uses a thin layer of SiO₂ (coating) combined with a cellulose film (substrate) resulting in a compostable product. Moreover, because this combination material may be produced in sheets, it readily adapts to fabrication. Thus, nearly any container size or shape imaginable can be constructed by numerous known methodologies.

Some advantages of the present invention include:
Biodegradable;
Compostable;
Inert substrate;
Impermeable to gas and liquids;
Economical to produce;
Efficient to manufacture;
Less energy to produce;
Less energy to recycle;
Educates and encourage sustainable practices;
Encourages the understanding of the material so consumers are intrigued;
Easy to adapt to many uses included food-stuff containers, consumables containers, disposable diapers, liquid storage vessels, etc.;
SiO₂ Ceramic coatings are inert;
An appropriate balance of inert material so to not prevent degradation through algae microbial life, and other boi-degrading organisms;
Both the substrate and coating (and the combination) are compostable and meet ASTM 6400 D (American Society for Testing and Materials);
Most material is FDA approved for food and beverage containers. The coating is not limited to food and beverage containers;
Ceramic coatings provide a higher oxygen, moisture, and static dissipative barrier to the films enabling applications of the material in the food, beverage, medical, agricultural and electronic packaging industries;
Ceramic coatings add strength to the film (substrate);
Different coating and thickness are different characteristics to the substrates;
Different coating is more feasible from the processing side and speed of which a coating can coat as well as the amount of material that can be coated;
Electric coating (ceramis-brand or similar) has a very fast and coast effective process and has more flexibility then other process;
Bath and electro static is more expensive slower and adds additional steps but has a superior strength when it is required by the inert or ceramic coating;
By varying the amount of ceramic coating to the film (substrate), material characteristics can be fine-tuned for the intended application. For example, the amount of ceramic coating and the substrate thickness will impact flexibility, stability, permeability, and degradation;
Static dissipative, oxygen and moisture barrier properties;
The material can easily be formed into various containers including bags, lids, pouches, formed products;
The material can be run on conventional converting equipment including vertical or horizontal forms, fill pouch, and stand up pouch, center folded, heat-sealed and formed, tubing, bags on rolls, and bags with and without closure devices;
Can be formed into lids, and valve-like tabs on the side of juice cartons made from foils or paper;
Some of the substrate materials lend themselves to a self-closing container because of the dead fold characteristic. By simply folding the container will seal. This allows more weight to be sealed in a given sized container. For example, coffee beans bags and films are formed and then heat sealed on equipment at the processing or roasting facility. Once the consumer opens the package, re-sealing must be accomplished by an auxiliary container, such as a “ziplock” baggie, or by utilizing auxiliary closing devices, such as rubber bands or clips. Instead, my invention enables self-sealing by simply folding over the opening, thus creating a seal. The seal can be made stronger by subsequent foldings. For example, a five-pound bag of coffee may require four or five folds—each fold adding to the strength of the seal;
The material could easily be laminated to other products, such as paper, to enhance and expand the applications of the material;
Safe to the environment; and
Ingestible by animal life would not harm the animal. Although they might choke because of the mass but would not harm the animal if ingested.
Silicone dioxide (SiO2) coating film combined with a cellophane substrate provides superior clarity over metallic-coated PLA's of the prior-art, thus enhancing visual aesthetics of the material when used as packaging for products or food-stuffs.
The inert SiO2 coating enables nitrogen flushing packaging (i.e. for foodstuff) and further enables vacuum packaging.

### DESCRIPTION OF THE INVENTION

I. Introduction

The present invention combines two known substances, in a way never been done before, to yield a remarkable material that is compostable, safe to the environment, and impermeable to oxygen, water vapor, other gasses, and liquids. Thus, this new material is ideally suited to meet the ever-growing demand for compostable containers, as used in the food, beverage, agricultural, consumer products, medical, and waste industries, for example.

Essentially, the present invention combines a substrate, such as a cellulose or polylactic acid (PLA) film with a ceramic coating, such as SiO₂ (silicon oxide-oxide). Because both the substrate and coating are derived from organic substances, both completely degrade under natural conditions. Moreover, this biodegradation can occur under compost conditions as defined in numerous international standards, including at least ASTM D 6400.

II. Substrates

One possible set of substrates includes cellulose-type films. For example, the Cellophane™ range of cellulose films produced by Innovia Films Inc., 1950 Lake Park Drive, Smyrna, Ga. 30080, USA are well suited to serve as a substrate for this present invention. Other cellulose films, however, would work equally well. Common to suitable cellulose films are compliance with the United States Food and Drug Administration's regulations including, specifically, 21 CFR 177.1200. Other characteristics of suitable cellulose films include offering a good printing surface with excellent clarity and gloss, dimensional stability, and resistance to attack by acids, bases, salts, oils, fats, and solvents, aroma barrier,

Of course, being well understood by persons of ordinary skill in the art, untreated cellulose films permit water penetration. This characteristic, although well suited for products that require moisture loss (i.e. baked goods), makes untreated cellulose ill-suited for many applications including food and beverage containers for food-stuffs containing any amount of liquids. Any oxygen or moisture, static dissipative application would improve because of the Ceramic types of coating.

Another possible substrate includes a polylactic polymer (PLA) such as the proprietary product made by Cargill Dow, LLC of Minnetonka, Minn., and USA. PLA, an organic material from a range of annually renewable resources processed from natural plant sugars, meets compostable requirements.

Eco Works™ biodegradable and compostable films and bags manufactured to a maximum thickness of 6.0 mils (per Cortec formulas Bio 1950, Bio-1900, Bio-1800, Bio-1750, Bio-1600) and Eco Film™ films and bags manufactured to a maximum thickness of 6.0 mils, available from Cortec Corporation of St. Paul, Minn., USA, are another a possible substrate. Other suitable substrates are manufactured by or under brand names such as Eastman Kodak, PSM, Navamount, Earthshell, Pliant, Natureworks PLA, Metaboliz using PHA, Treofan, Proctor and Gamble, Nodax, Toray PLA using Ecodaea, Basf, Eco, Flez, Mitisui Chemical, Lacea, Rodenburg, Solanyl, Tianan, Biologic PHBV, for example.

Films structures can be used for liding, Square bottom, valves, tubing center folded.

III. Coatings

One possible ceramic coating is a deposit of Silicon-dioxide (SiO₂). This particular coating is desirable because it is inert and provides an impermeable barrier to water vapor. In addition, it occurs naturally and breaks down under compostable conditions.

One suitable coating is the ceramic liquid sold under the brand name Nature Flex Coat. Another possible coating is Ceramis. A benefit of this coating is that it is flexible and has less of a tendency to crack; in addition, it is clear and inert.

IV. Methods of Manufacture

A. Liquid Deposit

For example, it is well understood in the art that cellulose fibers have hierachical porous structures in which metal particles can be readily synthesized and stabilized. See e.g. “Porous and nonporous AG nanostructures fabricated using cellulose fiber as a template” by Junhui He, published by the Royal Society of Chemestry 2005 in Chem. Commun., 2005, 795-796 available at www.rsc.org/chemcomm. In other applications, cellulose fibers are blended with synthetic polymers and more recently cellulose fibers have been coated with metal oxi gel layers. See e.g. “Nanocoating of natural cellulose fibers with conjugated polymer: hierarchical polypyrrole composit materials” by Jiangua Huang published by The Royal Society of Chemistyr 2005 in Chem. Commu., 2005, p. 1717 available at www.rsc.org/chemcomm. This well-understood structure of such cellulose sheets readily accepts silicone-dioxide particles. Accordingly, PS-2, Bemcott, 100% cellulose from Asahi Kasei, Japan can be used, this substrate comprises long uniform cellulose fibers of ca. 11 microns (μm). The surface of each fiber has pores of about 30-70 nm in size. By immersing such a sheet in an aqueous suspension of Silicone-dioxide (SiO2) compound, electrostatic interactions homogeneously distribute a fine layer of SiO2 on the cellulose sheet. Because the cellulose sheet is both compostable and bio-degradable, and because the fine layer of silicone-dioxide, an inert substance, does not impede bio-degradation and composting, yet provides a water-impermeable barrier, the novel material of the present invention is ideally suited for food, solids, liquids, and waste container applications.

B. Electrostatic Deposit

Another possible coating technique uses electrostatic deposits of the ceramic on the substrate. Yet another possibility is to make a three-layer material consisting of a first layer of the cellulose film substrate, a second layer of the ceramic material (deposited either in liquid form or electrostatic ally), and a third layer of the same cellulose film substrate. For example, a SiO2 coating of about 50 nm provides suitable barrier protection on a typical cellophane-type substrate.

V. Applications

Because the present invention is well suited to fabrication in sheets of multiple lengths, and because it is easy to cut, punch, or shear, it is well suited to a number of different shapes and arrangements. For example, by incorporating an organic adhesive, or adhesives that are so small in amount that they have no ramification to the degradability. Solvent specialties have such a line of adhesives both heat activated and pressure sanative. Overlapping edges of two sheets can be sealed with sufficient strength to form containers. For example, one possible adhesive is sold by BASF as Eco Flex. As long as less than 1% of the film volume includes adhesive, it is compostable. Thus, rectangular, oval, and cylindrical containers are easily manufactured. These containers would ideally serve as food, beverage, liquid waste, etc.

Suitable cellulose substrate materials are readily available and range in standard thicknesses including about 0.003 inches, 0.005 inches, 0.0075 inches 0.010 inches, 0.015 inches, 0.020 inches, 0.030 inches, 0.040 inches, 0.042 inches, 0.060, 0.080 inches, 0.100 inches, 0.125 inches, 0.150 inches, 0.187 inches, and 0.250 inches, for example, all of which are available from K-mac Plastics in Michigan, USA.

1. A biodegradable and compostable material comprising:
a substrate layer comprising cellulose and a coating comprising silicone-dioxide.

2. The material of claim 1 further wherein the substrate layer further comprises a nominal sheet thickness of about 0.001 inches to about 0.500 inches.

3. A biodegradable and compostable container comprising:
a container body comprising
at least one sidewall, the sidewall comprising a biodegradable and compostable material comprising a cellulose substrate coupled to a coating comprising silicone-dioxide.

4. The container of claim 3 further comprising a bottom member coupled to the at least one sidewall to form a void for holding a solid, liquid, gas, or any combination of solid, liquid, or gas, the bottom member comprising a biodegradable and compostable material comprising a cellulose substrate coupled to a coating comprising silicone-dioxide.

5. A biodegradable and compostable material comprising:
a first substrate layer comprising cellulose, a second substrate layer comprising cellulose and a film coating layer intermediate to the first and second substrate layers, the film coating layer comprising silicone-dioxide.
